(19) United States
(12) Patent Application Publication
(10) Pub. No.: US 2007/0148068 A1
(43) Pub. Date: Jun. 28, 2007

(54) Reclaiming amines in carbon dioxide recovery

(76) Inventors: Kenneth Leroy Burgers, East Amherst, NY (US); Shrikar Chakravarti, East Amherst, NY (US); William Robert Williams, Tewksbury, MA (US)

Correspondence Address: PRAXAIR, INC.;LAW DEPARTMENT - M1 557, 39 OLD RIDGEBURY ROAD, DANBURY, CT, 06810-5113, US

(21) Appl. No.: 11/314,999

(22) Filed: Dec. 23, 2005

(51) Int. Cl. B01D 53/14

(52) U.S. Cl. 423/220; 423/437.1

(57) ABSTRACT

Alkanolamine absorbent solution useful in recovering carbon dioxide from feed gas streams is reclaimed by subjecting it to vaporization in two or more stages under decreasing pressures.

### FIELD OF THE INVENTION

This invention relates generally to the recovery of carbon dioxide from gaseous feed mixtures.

### BACKGROUND OF THE INVENTION

Carbon dioxide is produced from feed streams with high CO₂ purity (which term as used herein means having a carbon dioxide content of ≧95%), where such streams are available, using distillation technology. Examples of such sources include ammonia and hydrogen plant off gases, fermentation sources and naturally-occurring gases in CO₂-rich wells. Typically, liquid CO₂ is produced at a central plant and then transported to users that could be hundreds of miles away, thereby incurring high transportation costs. The lack of sources with high concentrations of carbon dioxide and their distance from customers provides motivation to recover CO₂ from low concentration sources, which are generally available closer to customer sites. Predominant examples of such sources are flue gases, which typically contain 3-25% CO₂ depending upon the amounts of fuel and excess air used for combustion.

To produce high concentration product streams of CO₂ from sources having relatively low CO₂ concentrations, the CO₂ concentration in the feed gas needs to be upgraded significantly to create a higher-concentration stream that can be sent to a distillation unit. A variety of technologies—including membranes, adsorptive separation (PSA, VPSA, TSA), physical absorption and chemical absorption, can be used for upgrading the CO₂ purity. The economics (capital and operating costs) of the overall scheme depends upon the purity of the feed, the product purity specifications and recovery obtained. For membranes, adsorptive separations and physical absorption, the cost to obtain a certain high product purity is a strong function of the feed purity. On the other hand, chemical absorption provides a convenient means of directly obtaining high purity (which term as used herein means having a CO₂ content of ≧95%) CO₂ vapor in a single step because the costs of this technology are relatively insensitive to the feed CO₂ content. This vapor can be used as is or used as the feed to a CO₂ liquefaction plant.

Chemical absorption can be performed through the use of alkanolamines as well as carbonate salts such as hot potassium carbonate. However, when using carbonate salts, it is necessary for the partial pressure of CO₂ to be at least 15 psia to have any significant recovery. Since flue gases are typically available at atmospheric pressure, and the partial pressure of CO₂ in flue gases varies from about 0.5 to 3 psia, use of chemical absorption with carbonate salts would require compression of the feed gas. This is highly wasteful because of the significant energy expended in compressing the nitrogen that is also present. On the other hand, there exist alkanolamines that can provide adequate recovery levels of CO₂ from lean sources at atmospheric pressure. Thus for recovery of high purity (>95%) CO₂ vapor from sources such as flue gases, chemical absorption with amines is preferred.

The key steps in the chemical absorption process are the absorption of CO₂ from the flue gas into an amine solution at a relatively low temperature (around 100° F.), heating the resulting CO₂-rich amine solution to around 220° F., and subsequently stripping CO₂ from the rich solution at temperatures around 240° F. using steam.

Typically, flue gases contain significant amounts of oxygen (>2%), which can cause degradation of the amine(s) and other components of the absorbent. The degradation byproducts lead to corrosion problems as well as cause significant deterioration in the overall performance, such as a drop in CO₂ recovery.

In addition to oxidative degradation, aqueous amines are subject to several other degradation mechanisms, many of which result in the formation of compounds such as heat stable salts and other degradation byproducts. Heat stable salts and other degradation byproducts accumulate over a period of time in the liquid absorbent and can cause severe problems such as corrosion, foaming, reduction in production rate, and increased energy requirements. Efficient operation of amine processes therefore requires periodic or continuous removal of heat stable salts and other degradation byproducts compounds from the liquid absorbent. Typical processes employed in past techniques consume relatively high amounts of energy per unit of material treated.

Thus, there remains a need for processes that treat the amine absorbent solution in a more thermally efficient manner.

### BRIEF SUMMARY OF THE INVENTION

The present invention comprises a method for recovering carbon dioxide comprising:

(A) stripping a carbon dioxide containing absorbent solution to obtain therefrom a carbon dioxide rich fluid and a carbon dioxide depleted absorbent liquid, wherein said carbon dioxide containing absorbent solution is obtained by absorption of carbon dioxide from a feed gas comprising carbon dioxide into an absorbent at least a portion of which comprises said carbon dioxide depleted absorbent liquid;

(B) vaporizing at least a portion of said carbon dioxide depleted absorbent liquid to obtain a first reclaimed vapor stream and an unvaporized fraction;

(C) vaporizing a portion of said unvaporized fraction at a pressure lower than the lowest pressure at which step (B) is carried out to obtain a second reclaimed vapor stream and an unvaporized residue; and

(D) condensing said second reclaimed vapor stream and adding the resultant condensed stream to said absorbent into which carbon dioxide is absorbed in step (A).

As used herein, the term “absorption column” means a mass transfer device that enables a suitable solvent, i.e. absorbent, to selectively absorb the absorbate from a fluid containing one or more other components.

As used herein, the term “stripping column” means a mass transfer device wherein a component such as absorbate is separated from absorbent, generally through the application of energy.

As used herein the term “oxygen scavenging gas” means a gas that has an oxygen concentration less than 2 mole percent, preferably less than 0.5 mole percent, and which can be used to strip dissolved oxygen from a liquid.

As used herein, the terms “upper portion” and “lower portion” mean those sections of a column respectively above and below the mid point of the column.

As used herein, the term “indirect heat exchange” means the bringing of two fluids into heat exchange relation without any physical contact or intermixing of the fluids with each other.

### BRIEF DESCRIPTION OF THE DRAWING

FIG. 1 is a schematic representation of a carbon dioxide recovery process, showing the context in which the process of the present invention is carried out.

FIGS. 2-7 are schematic representations of embodiments of reclaiming sections of the present invention.

### DETAILED DESCRIPTION OF THE INVENTION

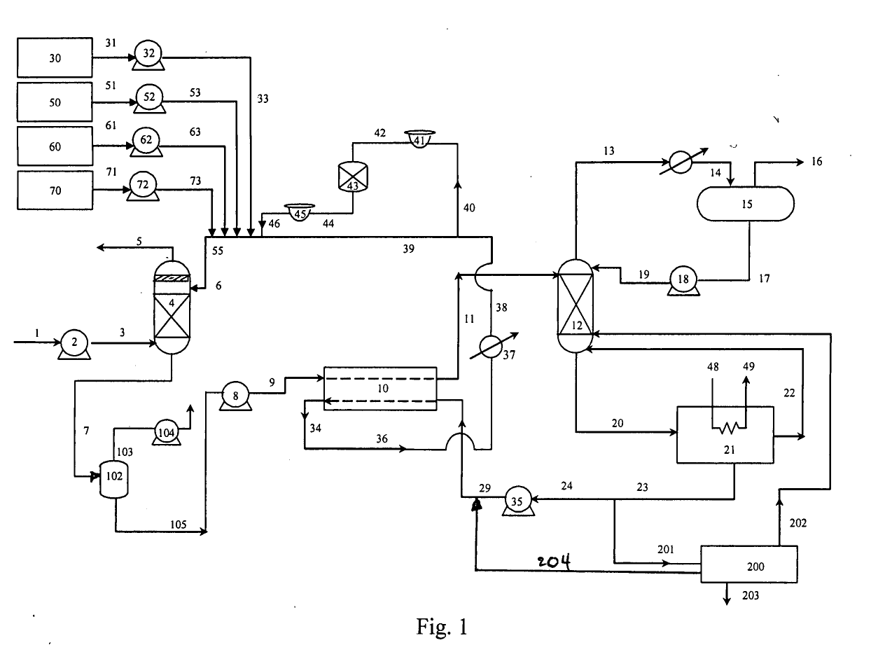

The present invention is particularly useful when employed as part of a process for recovering high purity carbon dioxide from a feed stream of relatively low purity carbon dioxide. One such process is illustrated in FIG. 1 and is described below with reference to FIG. 1 although no inference should be drawn that reference to the illustrated process is intended to be limiting of the scope of the present invention.

Referring to FIG. 1, feed gas mixture 1, which typically has been cooled and treated for the reduction of particulates and other impurities such as sulfur oxides (SOx) and nitrogen oxides (NOx), is passed to compressor or blower 2 wherein it is compressed to a pressure generally within the range of from 14.7 to 30 pounds per square inch absolute (psia). Feed gas mixture 1 generally contains from 2 to 50 mole percent carbon dioxide as the absorbate, and typically has a carbon dioxide concentration within the range of from 3 to 25 mole percent. Feed gas mixture 1 also contains oxygen in a concentration generally within the range of from less than 1 to about 18 mole percent. Feed gas mixture 1 may also contain one or more other components such as trace hydrocarbons, nitrogen, carbon monoxide, water vapor, sulfur oxides, nitrogen oxides and particulates. A preferred feed gas mixture is flue gas, by which is meant gas obtained upon the complete or partial combustion of hydrocarbon or carbohydrate material with air or with any other gaseous feed that contains oxygen.

Compressed feed gas mixture 3 is passed from blower 2 into the lower portion of absorption column 4 which is operating at a temperature generally within the range of from 40 to 45° C. at the top of the column and at a temperature generally within the range of from 50 to 60° C. at the bottom of the column. The absorption column typically operates at a pressure of atmospheric to 1.5 atmospheres.

Absorbent 6 is passed into the upper portion of absorption column 4. Absorbent 6 comprises water and at least one alkanolamine. Absorbent 6 optionally but preferably also contains an organic component, as described below.

Alkanolamines useful in the invention include single compounds, and mixtures of compounds, that conform to the formula NR¹R²R³ wherein R¹ is hydroxyethyl, hydroxyisopropyl, or hydroxy-n-propyl, R² is hydrogen, hydroxyethyl, hydroxyisopropyl, or hydroxy-n-propyl, and R³ is hydrogen, methyl, ethyl, hydroxyethyl, hydroxyisopropyl, or hydroxy-n-propyl; or wherein R¹ is 2-(2′-hydroxyethoxy)-ethyl, i.e. HO—CH₂CH₂OCH₂CH₂— and both R² and R³ are hydrogen. Preferred examples of alkanolamines which may be employed in absorber fluid 6 in the practice of this invention are monoethanolamine (also referred to as “MEA”), diethanolamine, diisopropanolamine, methyldiethanolamine (also referred to as “MDEA”) and triethanolamine.

The concentrations of the alkanolamine(s) in absorbent 6 are typically within the range of from 5 to 80 weight percent, and preferably from 10 to 50 weight percent. For example, a preferred concentration of monoethanolamine for use in the absorbent fluid in the practice of this invention is from 5 to 25 weight percent, more preferably from 10 to 15 weight percent.

Optionally, the absorbent 6 may also contain an organic component in addition to the amine component. The organic component is one or more of: C₁-C₃ alkanols, ethylene glycol, ethylene glycol monomethyl ether, diethylene glycol, propylene glycol, dipropylene glycol, a polyethylene glycol or polyethylene glycol ether of the formula R⁴—O—(C₂H₄O)ₙ—R⁵ wherein n is 3 to 12, R⁴ is hydrogen or methyl, R⁵ is hydrogen or methyl, or R⁴ is phenyl and R⁵ is hydrogen, a polypropylene glycol or polypropylene glycol ether of the formula R⁶—O—(C₃H₆O)ₚ—R wherein n is 3 to 6, R⁶ is hydrogen or methyl, R⁷ is hydrogen or methyl, or R⁶ is phenyl and R⁷ is hydrogen, acetamide which is unsubstituted or N-substituted with one or two alkyl groups containing 1 or 2 carbon atoms, glycerol, sulfolane, dimethylsulfoxide, and mixtures thereof. The organic component is water-soluble, and liquid at standard conditions of 25° C. at atmospheric pressure.

Examples of suitable organic components include methanol, ethanol, the monomethyl ether of ethylene glycol, the monophenyl ether of diethylene glycol, dimethyl acetamide, and N-ethyl acetamide. Other preferred organic components include glycols, glycol ethers, the aforementioned polyethylene glycols and ethers thereof, the aforementioned polypropylene glycols and ethers thereof, glycerol and sulfolane.

The organic component and the amount thereof are chosen so as to satisfy several factors. A primary factor is to reduce the absorbent solution's contributions of sensible and latent heat to the overall steam requirements in the regeneration section. The latent heat is reduced through the reduction of the relative amount of water that needs to be vaporized in the stripping column. A related factor is to decrease the heat capacity of the absorbent solution. Preferably, the heat capacity should be decreased by at least 10%, determined by comparing the heat capacity of a solution comprising water plus one or more amines, but no organic component as defined herein, to the heat capacity of an identical solution containing the same amount of the same one or more amines except that part of the water is replaced with the organic component. Typically the organic component is chosen so that the heat capacity of the absorbent solution decreases from about 0.9-1 cal/g ° C. for the absorbent comprising amine(s) and water but without the organic component, to about 0.65-0.9 cal/g ° C. for the absorbent comprising amine(s), water and organic component.

The choice of the particular organic component should take into consideration several other factors. One factor is flammability, which is important where the absorbent contacts a flue gas containing significant amounts of oxygen in the absorber. For example, alcohols are not preferred organic components where the feed gas from which CO₂ is to be recovered contains enough oxygen to present a highly oxidizing environment. Another factor is environmental considerations, where the gas stream leaving the top of the absorber 4 is vented to the atmosphere without further treatment to remove the organic component or to chemically modify it, e.g. by combusting it. In such situations, organic components should be avoided that may pose health hazards or that may cause atmospheric odor or degradation. Yet another factor is that the organic component should be chemically compatible with the amine(s) as well as with materials employed in the system with which the organic component may come into contact, including not only vessels, pumps and lines but also gaskets, seals, valves and other parts.

Also important in the selection of the organic component and its amount(s) are a) maintaining the vapor pressure of the absorbent solution at values that would minimize absorber vent losses, b) maintaining or increasing the reaction rate of the absorbent solution with CO₂ in the absorber, and c) reducing any tendency of the absorbent solution to foam in the absorber.

When the aforementioned organic component is present in the absorbent solution, the absorbent solution can have a lower heat capacity which can result in an increased temperature within the absorber 4. It is therefore necessary to adjust the solution composition so as not to let the temperature in the absorber 4 exceed 85° C. and preferably 75° C. Also, the absorbent solution with the organic component should be formulated so that its boiling point does not become so high that the stripper needs to be operated at temperatures above about 130° C. at any point, to avoid thermally degrading the amine absorbent in the stripper.

Taking all of the foregoing factors into account, when an organic component is also present the total amine should comprise 20 to 60 wt %, and preferably 25 to 50 wt %, the total of the organic component should comprise 10 to 50 wt % and preferably 25 to 40 wt %, and water should comprise 10 to 50 wt % and preferably 20 to 40 wt % of the absorbent solution.

Some examples of compositions of typical absorbent solutions that also include organic component in accordance with the present invention are:

30 wt. % MEA, 30 wt. % ethylene glycol, 40 wt. % water

30 wt. % MEA, 40 wt. % diethylene glycol, 30 wt. % water

25 wt. % MEA, 25 wt. % MDEA, 30 wt. % diethylene glycol, 20 wt. % water

30 wt. % MEA, 20 wt. % MDEA, 30 wt. % diethylene glycol, 20 wt. % water

Within absorption column 4 the feed gas mixture rises in countercurrent flow against downflowing absorbent. Absorption column 4 contains column internals or mass transfer elements such as trays or random or structured packing. As the feed gas rises, most of the carbon dioxide within the feed gas, small amounts of oxygen and other species such as nitrogen, are absorbed into the downflowing absorber liquid resulting in carbon dioxide depleted top vapor at the top of column 4, and in carbon dioxide loaded absorbent containing dissolved oxygen at the bottom of column 4. The top vapor is withdrawn from the upper portion of column 4 in stream 5 and the carbon dioxide loaded absorbent is withdrawn from the lower portion of column 4 in stream 7.

A mist eliminator can be provided at the top of the absorber to trap amine and/or organic component that is entrained in the absorber vent gas 5, which is essentially enriched nitrogen. To aid in removal of amine and organic component, a water wash could be used either in addition to the mist eliminator or instead of the mist eliminator.

As dissolved oxygen eventually causes degradation of alkanolamines and some organic diluents thereby leading to corrosion and other operating difficulties, it is optional but preferred to reduce the concentration level of dissolved oxygen in the carbon dioxide loaded absorbent by next conveying the carbon dioxide and oxygen containing absorbent stream 7 to a stage in which oxygen is removed from the stream.

Complete elimination of oxygen is ideal but not necessary. Reduction of the oxygen concentration to less than 2 ppm oxygen and preferably less than 0.5 ppm oxygen should be achieved. A preferred technique for oxygen removal is a vacuum flash as shown in FIG. 1. In this technique, the carbon dioxide and oxygen containing absorbent solution is fed to a tank 102 in which the pressure in the head space over the absorbent solution is maintained subatmospheric, generally within the range of 2 to 12 psia and preferably within the range of from 2.5 to 6 psia, by operation of vacuum pump 104. This condition withdraws oxygen and other dissolved gases from the solution and out of the upper portion of tank 102 via line 103.

Oxygen can also be removed by contacting the solution with an oxygen scavenging gas in a suitable mass transfer device such as a packed column, sparging device, or membrane contactor in place of or in addition to tank 102, but preferably located in the process scheme where tank 102 is located. Equipment and methodology useful in employing an oxygen scavenging gas are described in U.S. Pat. No. 6,174,506. Examples of useful oxygen scavenging gases include gases with no or very little oxygen, e.g. nitrogen, carbon dioxide vapor leaving the regeneration section, or carbon dioxide from the storage tank.

It is an important aspect of this invention that the fluid comprising stream 7 either undergoes no heating between its withdrawal from absorption column 4 and its treatment to remove oxygen, or is heated (in aid of the oxygen removal technique) but not so much that the temperature of stream 7 exceeds 160° F. (71° C.).

The resulting carbon dioxide containing oxygen depleted absorbent, typically containing less than 2 ppm oxygen and preferably less than 0.5 ppm oxygen, is withdrawn from the lower portion of tank 102 in stream 105, passed to liquid pump 8 and from there in stream 9 to and through heat exchanger 10 wherein it is heated by indirect heat exchange to a temperature generally within the range of from 90 to 120° C., preferably from 100 to 110° C.

The heated carbon dioxide containing absorbent is passed from heat exchanger 10 in stream 11 into the upper portion of stripping column (or “stripper”) 12, which operates at a temperature typically within the range of from 100 to 110° C. at the top of the column and at a temperature typically within the range of from 119 to 125° C. at the bottom of the column, and at a pressure typically from 20 to 65 psia. As the heated carbon dioxide loaded absorbent flows down through stripping column 12 over mass transfer elements which can be trays or random or structured packing, carbon dioxide within the absorbent is stripped from the absorbent into upflowing vapor, which is generally steam, to produce carbon dioxide rich top vapor stream 13 and carbon dioxide-depleted absorbent liquid stream 20.

The carbon dioxide rich top vapor stream 13 is withdrawn from the upper portion of stripping column 12 and passed through reflux condenser 47 wherein it is partially condensed. Resulting two phase stream 14 is passed to reflux drum or phase separator 15 wherein it is separated into carbon dioxide rich gas and into condensate.

The carbon dioxide rich gas is removed from phase separator 15 in stream 16 and recovered as carbon dioxide product fluid having a carbon dioxide concentration generally within the range of from 95 to 99.9 mole percent on a dry basis. By “recovered” as used herein it is meant recovered as ultimate product or separated for any reason such as disposal, further use, further processing or sequestration. The carbon dioxide product (stream 16 in FIG. 1) is generally of high purity (>98%). Depending on how it will be used, it can be used as vapor CO₂ without further purification, or with additional purification as would the case if it is to be used as an ingredient in a beverage or other edible product. Alternatively, this stream can be fed to a liquefaction unit for production of liquid CO₂.

The condensate, which comprises primarily water, amine(s) and the organic component, is withdrawn from phase separator 15 in stream 17. Preferably, this stream is passed through liquid pump 18 and fed as stream 19 into the upper portion of stripping column 12. However, pump 18 is unnecessary if the condensate can flow by gravity to the stripper. Alternatively, this stream can be reintroduced into the process elsewhere, such as into stream 20.

Remaining carbon dioxide depleted absorbent containing alkanolamine(s), water, and organic component (if organic component is employed) is withdrawn from the lower portion of stripping column 12 in stream 20. Preferably, this absorbent is recycled to comprise at least a portion of stream 6 fed to absorption column 4. Before that, preferably, stream 20 is passed to reboiler 21 wherein it is heated by indirect heat exchange, to a temperature typically within the range of from 119 to 125° C. In the embodiment of the invention illustrated in FIG. 1, reboiler 21 is driven by saturated steam 48 at a pressure of 28 pounds per square inch gauge (psig) or higher, which is withdrawn from reboiler 21 in stream 49.

The heating of the carbon dioxide depleted absorbent in reboiler 21 vaporizes a portion of that absorbent to produce initial vapor stream 22 which comprises steam and possibly some alkanolamine(s) and organic component. Initial vapor stream 22 is passed from reboiler 21 into the lower portion of stripping column 12 wherein it serves as the aforesaid upflowing vapor. The remaining carbon dioxide depleted absorbent liquid (which may contain alkanolamine and organic component if such is employed) is withdrawn from reboiler 21 in stream 23.

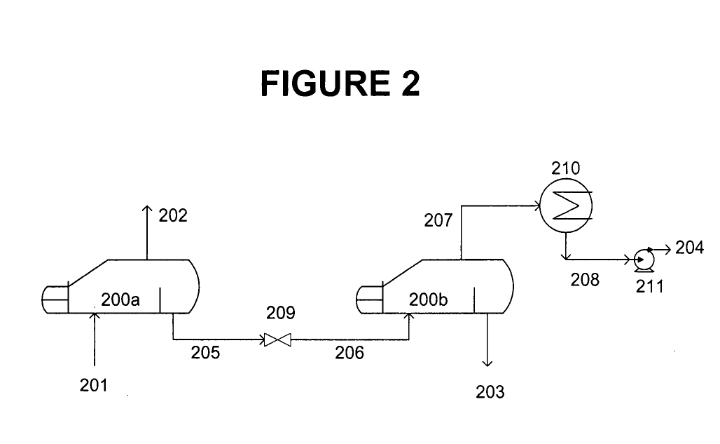

Stream 23 is divided into streams 201 and 24. Stream 201 is fed to reclaimer 200 for further treatment as described hereinbelow with respect to FIGS. 2-7.

The remaining portion 24 of the heated carbon dioxide depleted absorbent 23 is passed to solvent pump 35 and from there in stream 29 to and through heat exchanger 10 wherein it serves to carry out the aforesaid heating of the carbon dioxide containing absorbent and from which it emerges as cooled absorbent stream 34. Stream 34 is cooled by passage through cooler 37 to a temperature of about 40° C. to form further-cooled absorbent stream 38. A portion 40 of stream 38 is separated and passed through mechanical filter 41, from there as stream 42 through carbon bed filter 43, and from there as stream 44 through mechanical filter 45, for the removal of impurities, solids, degradation byproducts and heat stable amine salts. Resulting purified stream 46 is recombined with stream 39 which is the remainder of stream 38 to form stream 55.

Storage tank 30 contains makeup amine, which as required is withdrawn from storage tank 30 in stream 31 and pumped by liquid pump 32 as stream 33 into stream 55. When a second amine is used, storage tank 50 contains makeup for the second amine. The second amine is withdrawn from storage tank 50 in stream 51 and pumped by liquid pump 52 as stream 53 into stream 55. Alternatively, the amine compounds can be preblended, and held in and dispensed from but one storage tank. Third and additional amines can be stored in and dispensed from third and additional storage tanks. Storage tank 60 contains makeup water, which as required is withdrawn from storage tank 60 in stream 61 and pumped by liquid pump 62 as stream 63 into stream 55. Storage tank 70 contains makeup for the organic component, which as required is withdrawn from storage tank 70 in stream 71 and pumped by liquid pump 72 as stream 73 into stream 55 to form stream 6.

The method of the present invention reclaims the desired relatively volatile water and alkanolamine compound(s) used in the carbon dioxide absorption process by carrying out the reclamation under at least two different pressures, the second being lower than the first. Doing so reduces the overall energy requirements of the reclamation process and minimizes the operating costs. Reclamation is performed by vaporizing material from the carbon dioxide depleted absorbent, and then from the resulting unvaporized fraction, in suitable apparatus such as heat exchangers.

This method is particularly useful when the carbon dioxide depleted absorbent liquid contains primary amines that are less volatile than monoethanolamine, or when it contains one or more secondary and/or tertiary amines (i.e. when one or both of R² and/or R³ is a substituent other than hydrogen), or when the absorbent liquid contains an organic component as that term is defined herein. The method of the present invention is also useful when an amine or an organic component is present that is susceptible to thermal degradation. It is also particularly useful when the pressure of available steam is limited.

Some considerations are applicable to all embodiments of this aspect of the invention. One consideration is that the stream 201 fed to the reclaiming operation may be treated with alkali such as sodium oxide or sodium hydroxide to help free amine to be recovered from amine salt and to cause precipitation of heat stable salts. Another consideration is that the temperatures used in all vaporization steps may be about the same, but do not necessarily have to be the same. The temperature(s) used should be no greater than the degradation temperature of the most readily degraded component of the solution being subjected to vaporization conditions. Often, the temperature(s) will be set by the availability of a low value heat source such as low pressure steam, provided that its temperature is less than the degradation temperature described above. Higher temperatures (below the maximum at which degradation can begin) will result in a greater fraction of the absorbent solution being vaporized in the earlier vaporization stage(s) and will contribute to the overall thermal efficiency of a multistage reclaiming process. For solutions containing monoethanolamine, a typical temperature at which to carry out vaporization would be about 290° F.

Another consideration of the operation of the present invention is that vaporization is carried out in any apparatus that can tolerate the absorbent liquid being vaporized and the temperature and pressure conditions under which the vaporization is carried out. Suitable equipment such as heat exchangers or kettles can readily be determined and obtained. Heat is added to each of the vaporization units described in the embodiments illustrated and described herein, to accomplish the vaporization. The pressure can be established using a vacuum pump which establishes the desired vacuum to allow the vaporization to proceed at a lower temperature at which thermal degradation of the amines is reduced or avoided.

The first such vaporization stage is preferably carried out at a pressure of 20 to 65 psia that is slightly higher than the pressure in stripper 12, so that the vapor obtained in this stage can flow to the stripper. The vapor, termed herein the first reclaimed vapor stream, that is obtained in the first vaporization stage is shown in FIGS. 1-7 as stream 202. Stream 202 is preferably returned to the carbon dioxide depleted absorbent liquid or to a process unit that generates or treats the carbon dioxide depleted absorbent liquid, such as reboiler 21 or stripper 12. Preferably stream 202 is fed to stripper 12, as shown in FIG. 1, so that energy used in the first vaporization stage is recovered in stripper 12 as latent heat from the first reclaimed vapor stream; this latent heat contributes to the heat provided by the reboiler for stripping carbon dioxide from the absorbent.

The unvaporized fraction remaining from the first vaporization stage, comprising liquid and solids dissolved or suspended therein, is treated in a second vaporization stage. Recognizing that the pressure in the first vaporization stage may vary over a range, the pressure of the second vaporization stage is less than the lowest pressure employed in the first vaporization stage during at least a portion of, and preferably during all of, the operation of the second vaporization stage. In most cases the pressure in the second vaporization stage is subambient, typically 0.5 psia to 5 psia. The vapor, termed herein the second reclaimed vapor stream, that is formed in and recovered from the second vaporization stage can be condensed and recombined with the carbon dioxide depleted absorbent.

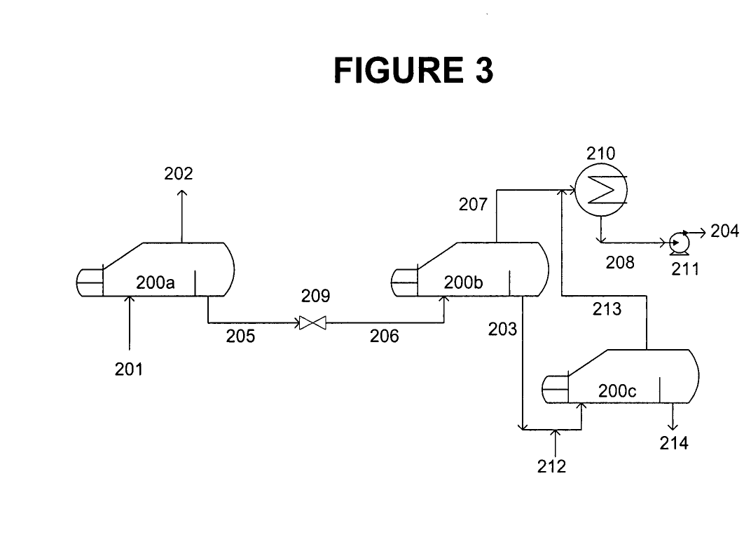

To improve solvent recovery, an optional third vaporization stage may be used, as is shown in FIG. 3. In practicing with a third stage, it will often be helpful to add to the unvaporized residue from the second vaporization stage a small amount of water (typically up to about 50% by weight of the amount of unvaporized residue present) and the diluted residue is vaporized, at about the same pressure as employed in the second vaporization stage. Typically, the pressure in this stage is 0.5 psia to 5 psia. Vapor from the third vaporization stage can be condensed and added to the recirculating carbon dioxide depleted absorbent.

The residue from the last vaporization stage (e.g. the second vaporization stage of a process employing two vaporization stages, or the third vaporization stage of a process employing three vaporization stages) is not used further in the carbon dioxide recovery process (unless it is subjected to vaporization in fourth or further vaporization stages to recover incremental amounts of alkanolamine(s)) and so can be discarded or collected for further processing. This residue typically comprises heat stable amine salts and other products formed by degradation of the alkanolamine absorbent.

FIGS. 2-7 should now be referred to for the following more detailed description of embodiments of the present invention.

FIG. 2 depicts a preferred mode of operation in utilizing a two-stage reclaimer operated in a continuous manner. Stream 201 of carbon dioxide depleted absorbent liquid is fed to first vaporization unit 200a. The temperature in unit 200a is typically 250° F. to 300° F. A portion, comprising primarily the most volatile components of this liquid, is vaporized in first vaporization unit 200a. The resulting first reclaimed vapor stream 202 exits the first vaporization unit. It is preferred to send this stream to the bottom portion of stripper 12, where the latent heat of this vapor stream may be used to decrease the heat requirement of reboiler 21. However, as described herein, stream 202 can be fed to reboiler 21 or combined with the carbon dioxide depleted stream.

The fraction of the carbon dioxide depleted absorbent liquid that did not vaporize, 205, is sent through valve 209, where it is reduced in pressure. The pressure is preferably reduced to a value in the range of 0.5 psia to 5 psia. The resulting lower pressure stream, 206, is sent to a second vaporization unit 200b. The temperature in unit 200b is typically about 250° F. to 300° F. and can be about the same as the temperature in unit 200a. A portion of the liquid is vaporized in unit 200b and the resulting second reclaimed vapor stream 207 is condensed in a cooler 210. The resulting condensate 208 is pumped by pump 211 as stream 204 which can be employed to absorb additional carbon dioxide from an incoming feed gas stream. As such, stream 204 can be recombined with stream 29 or at any point along the course of stream 29 becoming stream 6.

Condensing of stream 207 in condenser 210 is preferably carried out in a manner that enables the condensation to assist in establishing the desired low pressure in unit 200b. If noncondensible gases are also present in the stream, such as may be present due to vacuum leaks, it may be necessary to use additional means to establish the low pressure, such as a small vacuum pump.

The unvaporized residue 203, which comprises heat stable salts and other degradation byproducts, can be removed from unit 200b and discarded or further processed.

FIG. 3 depicts another preferred mode of operation in which a three-stage reclaimer is operated in a continuous manner. The first two stages are analogous to the two-stage embodiment shown in FIG. 2. The third stage improves recovery of less volatile but still desirable components from the unvaporized residue 203. Preferably, before or during vaporization in unit 200c, a small amount of liquid water is fed as stream 212 and combined with the unvaporized residue, typically up to 50% water by weight of the unvaporized residue to which the water is added. The resulting mixture is treated in third vaporization unit 200c to vaporize relatively volatile components from the residue. The water aids in volatilization of desired components from the residue.

Vaporization in the third vaporization stage can be carried out at about the same temperature as in units 200a and 200b. The pressure in unit 200c is typically 0.5 psia to 5 psia. Compared to the pressure in second unit 200b, the pressure in third unit 200c is the same as or less than the lowest pressure used in unit 200b. It may be advantageous to locate unit 200c at a lower elevation than unit 200b, to facilitate the free flow of residual liquid from unit 200b to unit 200c while maintaining approximately the same pressure in the vapor space. Third reclaimed vapor stream 213 is formed by the vaporization in the third vaporization unit 200c and may be combined with the second reclaimed vapor stream 212 with the combined streams being sent to the condenser 210. The unvolatilized residue remaining in unit 200c, comprising heat stable salts and other degradation byproducts, can be removed as stream 214.

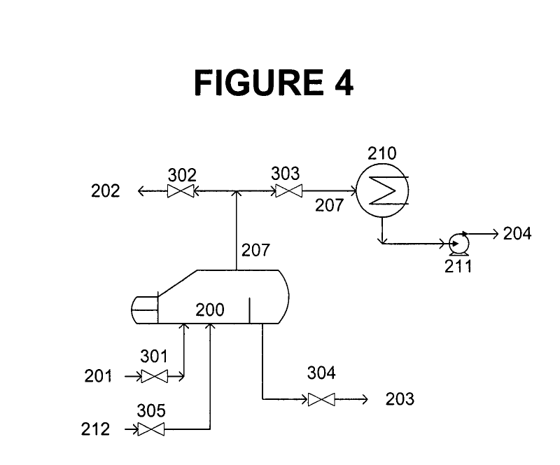

FIG. 4 depicts still another preferred embodiment of the invention in which the reclaiming is carried out in a batch manner. Batchwise vaporization can be performed in a single heat exchanger or other vaporization unit, operated at pressures which decrease continuously or stepwise over a period of time. Therefore this mode of operation requires less equipment than the continuous processes. However, batchwise operation can also be carried out in a series of vaporization units operated at decreasing pressures, like those shown in FIGS. 2 and 3.

Referring to FIG. 4, stream 201 of carbon dioxide depleted absorbent liquid is fed in batches through valve 301 to vaporization unit 200. The position of valve 301 may typically be controlled by a liquid level controller on unit 200. The temperature in vaporization unit 200 is maintained below the temperature at which any of the components will thermally degrade. Typically, the temperature at this stage of the operation is 250° F. to 300° F. The initial pressure in unit 200 can be in the range of 20 psia to 65 psia and is preferably slightly higher than the pressure in stripper 12.

Material that vaporizes in vaporization unit 200 leaves unit 200 as stream 220. In the first portion of the batchwise operation in unit 200, valve 302 is open and valves 303, 304 and 305 are closed, enabling the vapor in stream 220 to leave the unit as first reclaimed vapor stream 202 which is fed to stripper 12, where the latent heat of stream 202 may be used to reduce the amount of heat required of the reboiler.

As the batch vaporization operation continues, the liquid in heat exchanger 200 becomes concentrated in less volatile components. Eventually, less vapor and perhaps little or even no vapor at all is generated at the temperature and pressure prevailing in unit 200. The reclamation is then continued in a second step by carrying out vaporization at lower pressures, while (in the apparatus depicted in FIG. 4) valve 302 is closed and valve 303 is opened.

The pressures at which the vaporizations are carried out in the first vaporization step and in the second vaporization step may lie in ranges that do or do not overlap, but the pressure at which the second step is carried out in the same unit does become lower than the lowest pressure at which the first step is carried out.

Vapor from vaporization unit 200 exits at reduced pressure in stream 220 becomes second reclaimed vapor stream 207 and is condensed by condenser 210. The condensate is sent by pump 211 as stream 204 to the circulating carbon dioxide depleted absorbent liquid 29. The pressure during this part of the batch cycle is decreased steadily or stepwise with time and becomes subambient. Typically, the pressure in unit 200 in this portion of the vaporization is 0.5 psia up to the operating pressure of the stripper (20-65 psia).

When the rate of vaporization has slowed, one may add a small of liquid water 212 via valve 305 to assist vaporization of remaining amounts of less volatile but still desirable components of the absorbent liquid being treated. This aspect is analogous to operation of the third vaporization stage described above in connection with FIG. 3. The unvaporized residue that remains in unit 200 comprises heat stable salts and other degradation byproducts and is removed as stream 203 by opening valve 304. It may be desired to treat several batches of carbon dioxide depleted absorbent liquid, each batch being subjected to a sequence of vaporization under decreasing pressure, before removing from unit 200 the heat stable salts and byproducts that are obtained.

Preferred compositions of the carbon dioxide depleted absorbent liquid are generally in the range of 5-30 wt % MEA, 0-40 wt % MDEA, and 30-70 wt % water. A more preferred composition is 20-30% MEA, 20-30% MDEA, and 40-60% water.

To reduce the energy requirement of the reclaiming operation, the best mode of operation uses the reclaimer only when needed, on as small a flow rate of the carbon dioxide depleted absorbent liquid as possible. Both batch and continuous processes may be turned on and off as desired.

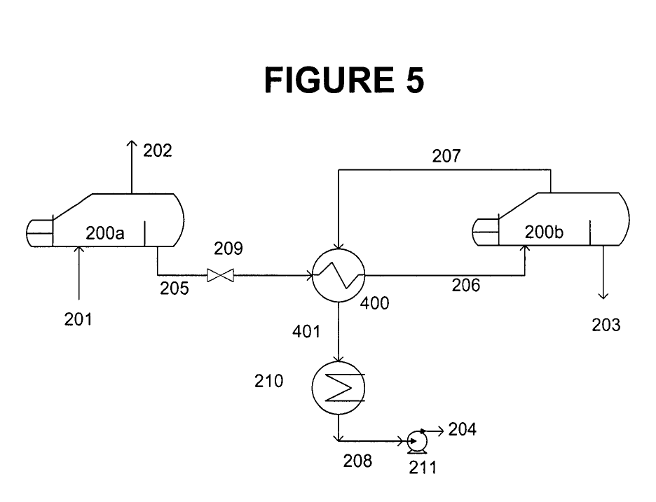

The thermal efficiency of the reclaimer process employed in this invention may be further improved by the incorporation of thermal recovery heat exchangers. The incorporation of such heat exchangers is shown in FIGS. 5, 6, and 7.

FIG. 5 depicts a two stage continuous reclaiming process of the type depicted in FIG. 2, to which a thermal recovery heat exchanger has been added. Stream 205 of unvaporized material from vaporization unit 200a, after passing through pressure reduction valve 209, is fed through heat exchanger 400 where it is heated and is then fed as stream 206 into vaporization unit 200b where, as with the operation depicted in FIG. 2, additional volatile material vaporizes from the absorbent liquid fed to unit 200b and is obtained from unit 200b as second reclaimed vapor stream 207. Stream 207 then passes through heat exchanger 400 where some of its latent heat is exchanged via indirect heat exchange to stream 205. The second reclaimed vapor stream emerges from heat exchanger 400 as stream 401 which is then fed to condenser 210 and is then further handled like stream 208 in FIG. 2.

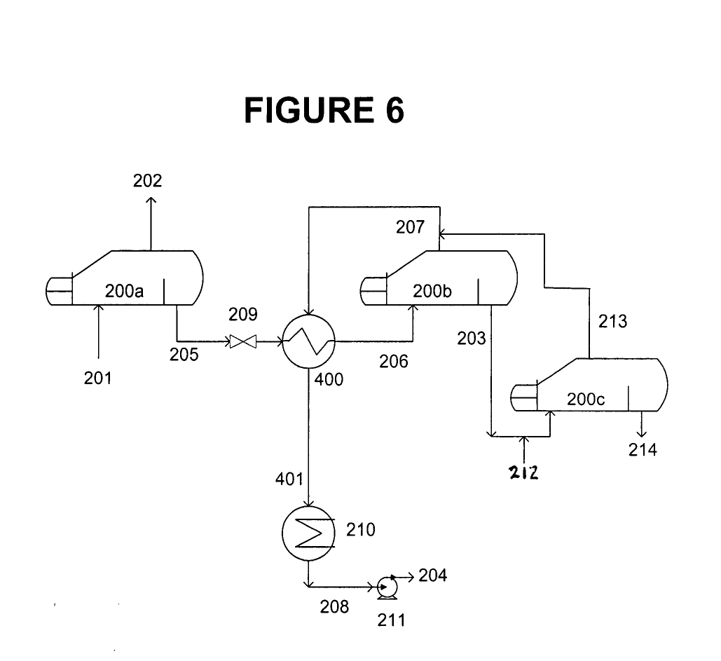

FIG. 6 depicts a three stage continuous reclaiming operation of the type depicted in FIG. 3, to which a thermal recovery heat exchanger has been added. Stream 205 of unvaporized material from vaporization unit 200a, after passing through pressure reduction valve 209, passes through heat exchanger 400 where it is heated and is then fed as stream 206 into vaporization unit 200b where, as with the operation depicted in FIG. 3, additional volatile material vaporizes from the absorbent liquid fed to unit 200b and is obtained from unit 200b as second reclaimed vapor stream 207. Stream 207 then passes through heat exchanger 400 where some of its latent heat is exchanged via indirect heat exchange to stream 205. The second reclaimed vapor stream emerges from heat exchanger 400 as stream 401 which is then fed to condenser 210 and is then further handled like stream 208 in FIG. 3. In addition, the unvaporized residue 203 is obtained from vaporization unit 200b, water 212 is added to it, and the resulting mixture is fed to another vaporization unit 200c. The third reclaimed vapor stream 213 that is obtained by vaporization carried out in unit 200c is combined with stream 207 and the combined stream passes through heat exchanger 400 before being fed through condenser 210 and recirculated to the carbon dioxide depleted absorbent stream 29. Alternatively, stream 205 can be heated by indirect heat exchange with only stream 207, with only stream 213, or with a stream formed by streams 207 and 213 already having been combined.

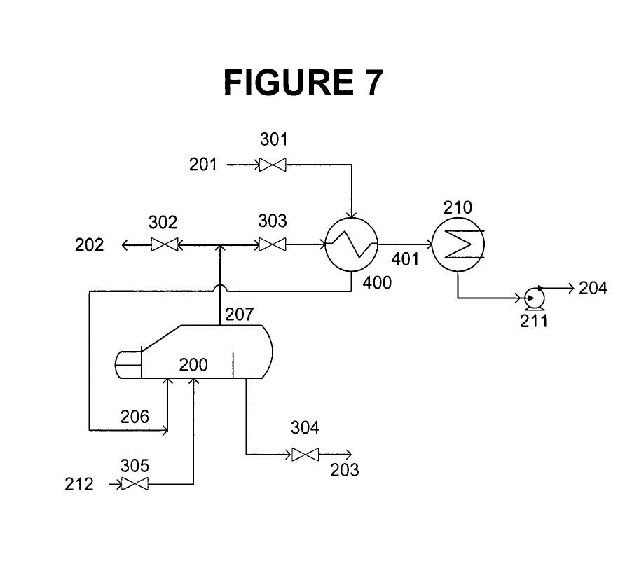

FIG. 7 depicts a batch reclaimer of the type depicted in FIG. 4, to which a thermal recovery heat exchanger has been added. Stream 201 of carbon dioxide depleted absorbent liquid is fed through heat exchanger 400 where it is heated and is then fed into vaporization unit 200. As is the case with the operation depicted in FIG. 4, a first reclaimed vapor stream 202 is obtained and fed to stripper 12, following which the pressure in unit 200 is reduced and valve 302 is closed and valve 303 is opened. The second reclaimed vapor stream that is then obtained is passed through heat exchanger 400 where some of its latent heat is passed via indirect heat exchange to stream 201. The second reclaimed vapor stream emerges from heat exchanger 400 as stream 401 which is condensed in condenser 210 and fed as stream 204 to stream 29.

In all cases, the thermal energy required to vaporize the absorbent liquid streams is reduced by using a heat exchanger 400 to preheat the feed stream that is to be fed to vaporization unit 200b used in the continuous-operation embodiments or to vaporization unit 200 used in batch operation. The heat used for this preheating is provided by the vapor stream obtained upon reduced-pressure vaporization, e.g. stream 205 in continuous operation and stream 207 in batch operation.

### EXAMPLES

Performance and operating conditions, as predicted by process simulation, are shown for a 100 MTPD CO₂ absorption system using as absorbent a solution containing 30 wt % MEA, 20 wt % MDEA, 50 wt % water and containing about 2 wt % of heat stable salts.
Type of Reclaimer: Continuous 3-stage with water addition to 3^{rd} stage
   Feed rate of absorbent stream: 10 gpm
   Temperature of First Vaporization Stage: 290 deg F.
   Pressure of First Vaporization Stage: 25.2 psia
   Heat to First Vaporization Stage: 2.331 MMBTUH (recoverable)
   Temperature of Second Vaporization Stage: 290 deg F.
   Pressure of Second Vaporization Stage: 1.4 psia
Heat to Second Vaporization Stage: 0.998 MMBTUH (not recoverable)
   Temperature of Third Vaporization Stage: 290 deg F.
   Pressure of Third Vaporization Stage: 1.4 psia
   Water Addition Rate to Third Vaporization Stage: 32 lb/hr
   Heat to of Third Vaporization Stage: 0.053 MMBTUH (not recoverable)
   Baseline Heat to Reboiler w/Reclaimer Off: 12.55 MMBTUH
   Baseline Steam Duty w/Reclaimer Off: 3.00 MMBTU/MT CO₂
   Steam Duty w/Reclaimer On: 3.25 MMBTU/MT CO₂
   For the same duty as above, the performance of a conventional vacuum reclaimer is predicted by process simulation to be as follows:
   Type of Reclaimer: Single stage vacuum
   Temperature: 290 deg F.
   Pressure: 4.6 psia
   Heat to Reclaimer: 3.348 MMBTUH
   Steam Duty w/Reclaimer Off: 3.00 MMBTU/MT CO₂
   Steam Duty w/Reclaimer On: 3.80 MMBTU/MT CO₂
   In the above examples, the predicted savings in thermal energy is (3.80−3.25)=0.55 MMBTU/MT CO₂.

For the above example using a 3 stage reclaimer with water addition, the incorporation of a thermal recovery heat exchanger with a 9 deg F. approach temperature would reduce the steam duty from 3.25 to 3.07 MMBTU/MT CO₂. Thus, it can be seen that the practice of the present invention affords a significant advantage in reduced energy consumption per unit of carbon dioxide recovered,

What is claimed is:

1. A method for recovering carbon dioxide comprising:
(A) stripping a carbon dioxide containing absorbent solution to obtain therefrom a carbon dioxide rich fluid and a carbon dioxide depleted absorbent liquid, wherein said carbon dioxide containing absorbent solution is obtained by absorption of carbon dioxide from a feed gas comprising carbon dioxide into an absorbent at least a portion of which comprises said carbon dioxide depleted absorbent liquid;
(B) vaporizing at least a portion of said carbon dioxide depleted absorbent liquid to obtain a first reclaimed vapor stream and an unvaporized fraction;
(C) vaporizing a portion of said unvaporized fraction at a pressure lower than the lowest pressure at which step (B) is carried out to obtain a second reclaimed vapor stream and an unvaporized residue; and
(D) condensing said second reclaimed vapor stream and adding the resultant condensed stream to said absorbent into which carbon dioxide is absorbed in step (A).

2. A method according to claim 1 wherein the vaporizing in step (B) is carried out in a first vaporization unit, the unvaporized fraction obtained in step (B) is fed to a second vaporization unit, and the vaporizing of step (C) is carried out in said second vaporization unit.

3. A method according to claim 2 wherein the unvaporized fraction obtained in step (B) is heated prior to being fed to said second vaporization unit by indirect heat exchange with the second vaporization stream obtained in step (C).

4. A method according to claim 2 further comprising feeding the unvaporized residue obtained in step (C) to a third vaporization unit, and vaporizing a portion of said unvaporized residue in said third vaporization unit, to obtain a third reclaimed vapor stream and an unvolatilized residue, condensing said third reclaimed vapor stream, and feeding said condensed stream to step (A) to comprise a portion of said absorbent into which carbon dioxide is absorbed in step (A).

5. A method according to claim 4 wherein the unvaporized fraction obtained in step (B) is heated prior to being fed to said second vaporization unit by indirect heat exchange with the second vaporization stream obtained in step (C), with the third reclaimed vapor stream, or with both said vapor streams.

6. A method according to claim 1 wherein the vaporizing in step (B) and the vaporizing in step (C) are carried out in one vaporizing unit.

7. A method according to claim 6 wherein said portion of said carbon dioxide depleted absorbent solution, prior to being vaporized in step (B), is heated by indirect heat exchange with said second reclaimed vapor stream.

8. A method according to claim 1 wherein the absorbent into which carbon dioxide is absorbed in step (A) comprises an amine component which is selected from the group consisting of compounds of the formula NR¹R²R³ wherein R¹ is hydroxyethyl, hydroxyisopropyl, or hydroxy-n-propyl, R² is hydrogen, hydroxyethyl, hydroxyisopropyl, or hydroxy-n-propyl, and R³ is hydrogen, methyl, ethyl, hydroxyethyl, hydroxyisopropyl, or hydroxy-n-propyl; or wherein R¹ is 2-(2′-hydroxyethoxy)-ethyl and both R² and R³ are hydrogen, and mixtures thereof.

9. A method according to claim 8 wherein the vaporizing of step (B) is carried out in a first vaporization unit, the unvaporized fraction obtained in step (D) is fed to a second vaporization unit, and the vaporizing of step (C) is carried out in said second vaporization unit.

10. A method according to claim 9 wherein the unvaporized fraction obtained in step (B) is heated prior to being fed to said second vaporization unit by indirect heat exchange with the second vaporization stream obtained in step (C).

11. A method according to claim 9 further comprising feeding the unvaporized residue obtained in step (C) to a third vaporization unit, and vaporizing a portion of said unvaporized residue in said third vaporization unit, to obtain a third reclaimed vapor stream and an unvolatilized residue, condensing said third reclaimed vapor stream, and feeding said condensed stream to step (A) to comprise a portion of said absorbent into which carbon dioxide is absorbed in step (A).

12. A method according to claim 11 wherein the unvaporized fraction obtained in step (B) is heated prior to being fed to said second vaporization unit by indirect heat exchange with the second vaporization stream obtained in step (C), with the third reclaimed vapor stream, or with both said vapor streams.

13. A method according to claim 8 wherein the vaporizing in step (B) and the vaporizing in step (C) are carried out in one vaporizing unit.

14. A method according to claim 13 wherein said portion of said carbon dioxide depleted absorbent solution, prior to being vaporized in step (B), is heated by indirect heat exchange with said second reclaimed vapor stream.

15. A method according to claim 1 wherein the absorbent into which carbon dioxide is absorbed in step (A) comprises an organic component selected from the group consisting of C₁-C₃ alkanols, ethylene glycol, ethylene glycol monomethyl ether, diethylene glycol, propylene glycol, dipropylene glycol, polyethylene glycols and polyethylene glycol ethers of the formula R⁴—O—(C₂H₄O)ₙ—R wherein n is 3 to 12, R is hydrogen or methyl, R⁵ is hydrogen or methyl, or R⁴ is phenyl and R⁵ is hydrogen, polypropylene glycols and polypropylene glycol ethers of the formula R⁶—O—(C₃H₆O)ₚ—R wherein n is 3 to 6, R⁶ is hydrogen or methyl, R⁷ is hydrogen or methyl, or R⁶ is phenyl and R⁷ is hydrogen, acetamide which is unsubstituted or N-substituted with one or two alkyl groups containing 1 or 2 carbon atoms, glycerol, sulfolane, dimethylsulfoxide, and mixtures thereof

16. A method according to claim 15 wherein the vaporizing of step (B) is carried out in a first vaporization unit, the unvaporized fraction obtained in step (B) is fed to a second vaporization unit, and the vaporizing of step (C) is carried out in said second vaporization unit.

17. A method according to claim 16 wherein the unvaporized fraction obtained in step (B) is heated prior to being fed to said second vaporization unit by indirect heat exchange with the second vaporization stream obtained in step (C).

18. A method according to claim 16 further comprising feeding the unvaporized residue obtained in step (C) to a third vaporization unit, and vaporizing a portion of said unvaporized residue in said third vaporization unit, to obtain a third reclaimed vapor stream and an unvolatilized residue, condensing said third reclaimed vapor stream, and feeding said condensed stream to step (A) to comprise a portion of said absorbent into which carbon dioxide is absorbed in step (A).

19. A method according to claim 18 wherein the unvaporized fraction obtained in step (B) is heated prior to being fed to said second vaporization unit by indirect heat exchange with the second vaporization stream obtained in step (C), with the third reclaimed vapor stream, or with both said vapor streams.

20. A method according to claim 15 wherein the vaporizing in step (B) and the vaporizing in step (C) are carried out in one vaporizing unit.

21. A method according to claim 20 wherein said portion of said carbon dioxide depleted absorbent solution, prior to being vaporized in step (B), is heated by indirect heat exchange with said second reclaimed vapor stream.

22. A method according to claim 1 wherein said first reclaimed vapor stream is fed to stripping step (A) or into said carbon dioxide depleted absorbent liquid.

23. A method according to claim 22 wherein the vaporizing in step (B) is carried out in a first vaporization unit, the unvaporized fraction obtained in step (B) is fed to a second vaporization unit, and the vaporizing of step (C) is carried out in said second vaporization unit.

24. A method according to claim 23 wherein the unvaporized fraction obtained in step (B) is heated prior to being fed to said second vaporization unit by indirect heat exchange with the second vaporization stream obtained in step (C).

25. A method according to claim 23 further comprising feeding the unvaporized residue obtained in step (C) to a third vaporization unit, and vaporizing a portion of said unvaporized residue in said third vaporization unit, to obtain a third reclaimed vapor stream and an unvolatilized residue, condensing said third reclaimed vapor stream, and feeding said condensed stream to step (A) to comprise a portion of said absorbent into which carbon dioxide is absorbed in step (A).

26. A method according to claim 25 wherein the unvaporized fraction obtained in step (B) is heated prior to being fed to said second vaporization unit by indirect heat exchange with the second vaporization stream obtained in step (C), with the third reclaimed vapor stream, or with both said vapor streams.

27. A method according to claim 22 wherein the vaporizing in step (B) and the vaporizing in step (C) are carried out in one vaporizing unit.

28. A method according to claim 27 wherein said portion of said carbon dioxide depleted absorbent solution, prior to being vaporized in step (B), is heated by indirect heat exchange with said second reclaimed vapor stream.

29. A method according to claim 4 further comprising adding water to said unvaporized residue before or during vaporization thereof.

30. A method according to claim 28 wherein the vaporizing in step (B) is carried out in a first vaporization unit, the unvaporized fraction obtained in step (B) is fed to a second vaporization unit, and the vaporizing of step (C) is carried out in said second vaporization unit.

31. A method according to claim 30 wherein the unvaporized fraction obtained in step (B) is heated prior to being fed to said second vaporization unit by indirect heat exchange with the second vaporization stream obtained in step (C).

32. A method according to claim 30 further comprising feeding the unvaporized residue obtained in step (C) to a third vaporization unit, and vaporizing a portion of said unvaporized residue in said third vaporization unit, to obtain a third reclaimed vapor stream and an unvolatilized residue, condensing said third reclaimed vapor stream, and feeding said condensed stream to step (A) to comprise a portion of said absorbent into which carbon dioxide is absorbed in step (A).

33. A method according to claim 32 wherein the unvaporized fraction obtained in step (B) is heated prior to being fed to said second vaporization unit by indirect heat exchange with the second vaporization stream obtained in step (C), with the third reclaimed vapor stream, or with both said vapor streams.

34. A method according to claim 29 wherein the vaporizing in step (B) and the vaporizing in step (C) are carried out in one vaporizing unit.

35. A method according to claim 34 wherein said portion of said carbon dioxide depleted absorbent solution, prior to being vaporized in step (B), is heated by indirect heat exchange with said second reclaimed vapor stream.

36. A method according to claim 6 further comprising adding water to said unvaporized fraction before or during vaporization thereof.

37. A method according to claim 36 wherein the vaporizing in step (B) is carried out in a first vaporization unit, the unvaporized fraction obtained in step (B) is fed to a second vaporization unit, and the vaporizing of step (C) is carried out in said second vaporization unit.

38. A method according to claim 37 wherein the unvaporized fraction obtained in step (B) is heated prior to being fed to said second vaporization unit by indirect heat exchange with the second vaporization stream obtained in step (C).

39. A method according to claim 37 further comprising feeding the unvaporized residue obtained in step (C) to a third vaporization unit, and vaporizing a portion of said unvaporized residue in said third vaporization unit, to obtain a third reclaimed vapor stream and an unvolatilized residue, condensing said third reclaimed vapor stream, and feeding said condensed stream to step (A) to comprise a portion of said absorbent into which carbon dioxide is absorbed in step (A).

40. A method according to claim 39 wherein the unvaporized fraction obtained in step (B) is heated prior to being fed to said second vaporization unit by indirect heat exchange with the second vaporization stream obtained in step (C), with the third reclaimed vapor stream, or with both said vapor streams.

41. A method according to claim 36 wherein the vaporizing in step (B) and the vaporizing in step (C) are carried out in one vaporizing unit.

42. A method according to claim 41 wherein said portion of said carbon dioxide depleted absorbent solution, prior to being vaporized in step (B), is heated by indirect heat exchange with said second reclaimed vapor stream.

43. A method according to claim 1 wherein said condensing of said second reclaimed vapor stream assists in establishing the pressure at which the vaporization in step (C) is carried out.

44. A method according to claim 43 wherein the vaporizing in step (B) is carried out in a first vaporization unit, the unvaporized fraction obtained in step (B) is fed to a second vaporization unit, and the vaporizing of step (C) is carried out in said second vaporization unit.

45. A method according to claim 44 wherein the unvaporized fraction obtained in step (B) is heated prior to being fed to said second vaporization unit by indirect heat exchange with the second vaporization stream obtained in step (C).

46. A method according to claim 44 further comprising feeding the unvaporized residue obtained in step (C) to a third vaporization unit, and vaporizing a portion of said unvaporized residue in said third vaporization unit, to obtain a third reclaimed vapor stream and an unvolatilized residue, condensing said third reclaimed vapor stream, and feeding said condensed stream to step (A) to comprise a portion of said absorbent into which carbon dioxide is absorbed in step (A).

47. A method according to claim 46 wherein the unvaporized fraction obtained in step (B) is heated prior to being fed to said second vaporization unit by indirect heat exchange with the second vaporization stream obtained in step (C), with the third reclaimed vapor stream, or with both said vapor streams.

48. A method according to claim 43 wherein the vaporizing in step (B) and the vaporizing in step (C) are carried out in one vaporizing unit.

49. A method according to claim 48 wherein said portion of said carbon dioxide depleted absorbent solution, prior to being vaporized in step (B), is heated by indirect heat exchange with said second reclaimed vapor stream.
